(19) United States
(12) Patent Application Publication
(10) Pub. No.: US 2020/0054090 A1
(43) Pub. Date: Feb. 20, 2020

(54) STRENGTHENED HELMET WITH BUFFER PORTIONS AND MANUFACTURING METHOD THEREOF

(71) Applicant: MINSON ENTERPRISES CO., LTD., Taipei (TW)

(72) Inventor: Tai-Heng CHEN, Taipei (TW)

(73) Assignee: MINSON ENTERPRISES CO., LTD., Taipei (TW)

(21) Appl. No.: 16/104,718

(22) Filed: Aug. 17, 2018

(51) Int. Cl. A42B 3/06; A42B 3/12; B29C 45/26; B29C 45/40

(52) U.S. Cl. CPC A42B 3/062; A42B 3/125; B29L 2031/4821; B29C 45/40; B29C 45/26

(57) ABSTRACT

A helmet for ball sports has a main body and two strengthening elements. The two strengthening elements are mounted on two inner walls of the main body. A first surface of each strengthening element abuts and is connected to the main body. Second surfaces of the strengthening elements face to each other. Through holes of each strengthening element are formed through the first surface and the second surface so that the strengthening elements are latticed. With the helmet mounted with the strengthening elements on two sides, the strengthening elements enhance an anti-impact capacity on the two sides of the helmet. Besides, with the latticed strengthening elements, the weights of the strengthening elements are lightened and do not cause weighted burden on the neck of the user.

### BACKGROUND OF THE INVENTION

### 1. Field of the Invention

The present invention relates to a helmet and a manufacturing method of the helmet, especially to a helmet for ball sports and a manufacturing method of the helmet.

### 2. Description of the Prior Arts

A helmet is equipment that covers a head and thereby protects the head from impact by a hard object. Due to limitations in structure and shape, buffer portions, especially the portions that cover temples of a head, of the conventional helmet have a lower strength for anti-impact. Therefore, the conventional helmet may increase the thicknesses of the buffer portions for enhancing the anti-impact strength. However, even though the aforesaid method solves the defect of lower anti-impact strength at the buffer portions, a weight of the helmet is increased accordingly and thus a burden on a neck of a user is also heavier.

Consequently, how to improve the anti-impact capacity of the buffer portions of the helmet but keep the weight of the helmet below a maximum that the user can endure is an important issue for manufacturing a helmet.

### SUMMARY OF THE INVENTION

The main objective of the present invention is to provide a helmet that has strengthened buffer portions so that the helmet provides adequate anti-impact capacity and does not cause a weighted burden to the user.

The helmet has a main body and two strengthening elements. The main body comprises two buffer portions on two sides of the main body. The strengthening elements are respectively mounted on inner walls of the buffer portions of the main body. Each one of the strengthening elements includes a first surface, a second surface, and a plurality of through holes. The first surface is mounted on the inner wall of the corresponding buffer portion. The second surface faces to the second surface of the other strengthening element. The through holes are formed through the first surface and the second surface and thereby the strengthening element is latticed.

A manufacturing method of the helmet with strengthened buffer portions includes processes in sequence as follows. (1) Preparing a mode; wherein the mode comprises a male die and a female die, the male die comprises a plurality of lateral molding members and a demolding member, each one of the lateral molding members has a polygonal latticed groove, the demolding member has a plurality of inclined surfaces each for driving a respective one of the lateral molding members, the female die comprises a plurality of blocks; a mold cavity formed between the male die and the female die. (2) Injecting a liquid plastic ingredient into the mold, wherein the plastic liquid ingredient is injected into the mold cavity till the ingredient fills up the mold cavity and every latticed groove of the lateral molding members. After curing, the cured ingredient forms a helmet and strengthening elements formed in and shaped by the latticed grooves. (3) Releasing the helmet; the blocks of the female die are separated from each other and thereby release the male die and the helmet on the male die; then, the lateral molding members are moved inward along the inclined surfaces of the demolding member and thereby the strengthening elements respectively depart from the latticed grooves of the lateral molding members and thereby the helmet is released.

With the helmet mounted with the strengthening elements on two sides, the strengthening elements enhance the anti-impact capacity of the two sides of the helmet. Besides, with the latticed strengthening elements, the weight of the helmet is lighter than that of the conventional helmet, only increasing the thickness of the main body without causing the weighted burden to the neck of the user.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a helmet in accordance with the present invention;

FIG. 2 is a lateral sectional view of the helmet in FIG. 1;

FIG. 3 is a front sectional view of the helmet in FIG. 1;

FIG. 4 is an enlarged view of a buffer portion and a strengthening element in FIG. 3;

FIG. 5 is an exploded view of the helmet in FIG. 1;

FIG. 6 is an operational schematic view of the helmet in FIG. 1;

FIG. 7 is a diagram showing experimental data of impacting experiments, wherein the helmets are respectively made of four different materials, without the strengthening element, and the buffer portions having thicknesses ranging from 1.5 mm to 6 mm;

FIG. 8 is a diagram showing experimental data of impacting experiments, wherein the helmets are respectively made of four different materials, with the strengthening elements having thicknesses of 3 mm, and the buffer portions having thicknesses ranging from 1.5 mm to 6 mm;

FIG. 9 is a diagram showing experimental data of impacting experiments, wherein the helmets are respectively made of four different materials, with the strengthening elements having thicknesses of 3 mm, and the buffer portions having thicknesses ranging from 1.5 mm to 6 mm;

FIG. 10 is a diagram showing experimental data of impacting experiments, wherein the helmet is made of ABS, the thicknesses of the strengthening elements range from 0 mm to 6 mm, and the thicknesses of the buffer portions are 1.5 mm;

FIG. 11 is a diagram showing experimental data of impacting experiments, wherein the helmet is made of PE, the thicknesses of the strengthening elements range from 0 mm to 6 mm, and the thicknesses of the buffer portions are 1.5 mm;

FIG. 12 is a diagram showing experimental data of impacting experiments, wherein the helmet is made of PC, the thicknesses of the strengthening elements range from 0 mm to 6 mm, and the thicknesses of the buffer portions are 1.5 mm;

FIG. 13 is a diagram showing experimental data of impacting experiments, wherein the helmet is made of PC/ABS, the thicknesses of the strengthening elements range from 0 mm to 6 mm, and the thicknesses of the buffer portions are 1.5 mm; and

FIGS. 14 to 19 are serial operational views of a manufacturing method of a helmet in accordance with the present invention.

### DETAILED DESCRIPTION OF THE PREFERRED EMBODIMENTS

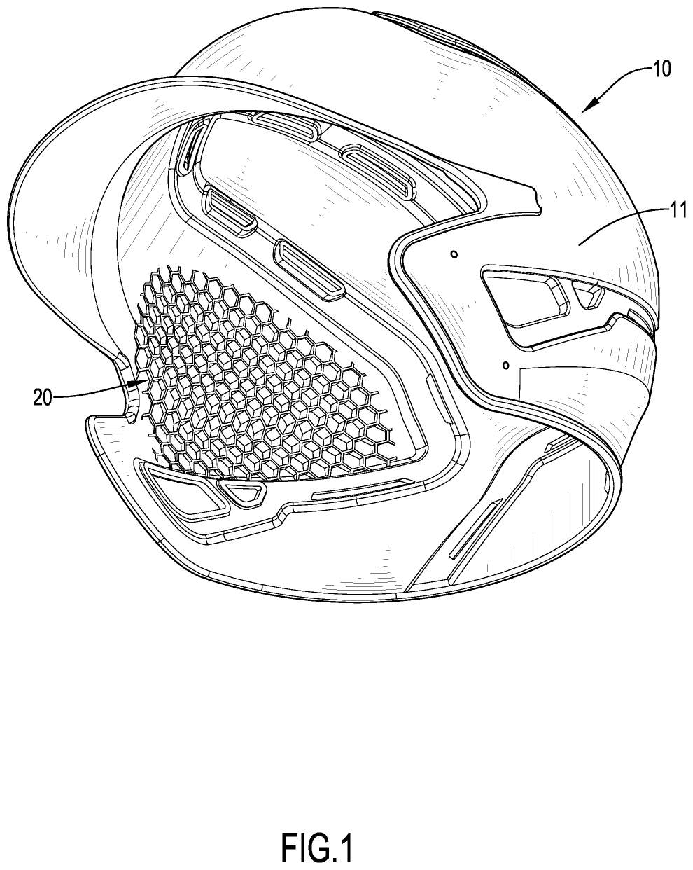

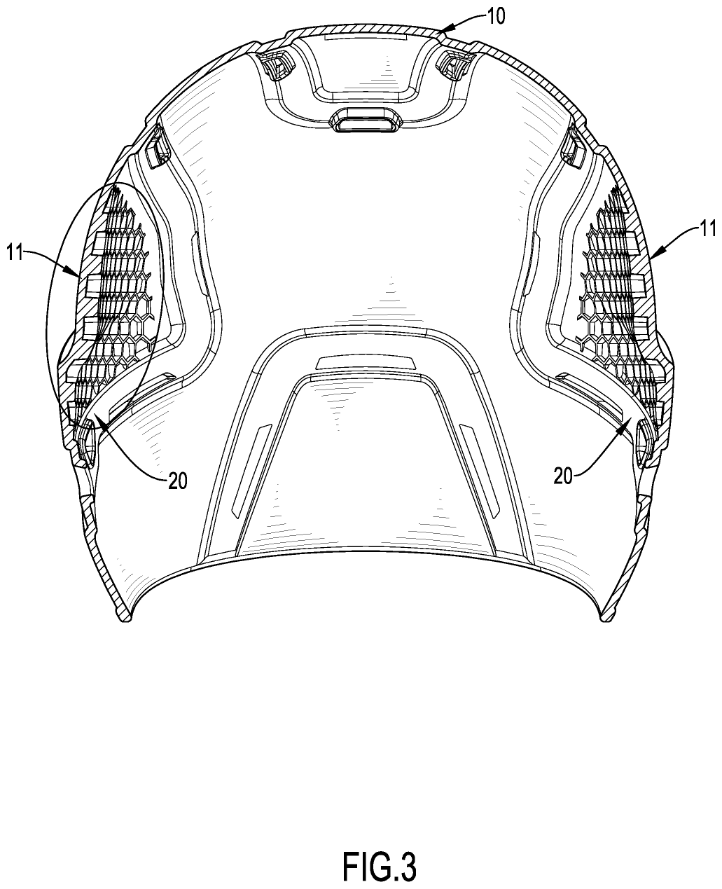

With reference to FIGS. 1 to 3, a helmet in accordance with the present invention comprises a main body 10, two strengthening elements 20, two first cushions 30, and two second cushions 40. In this embodiment, the main body 10 and the two strengthening elements 20 are formed integrally, but it is not limited thereto.

The main body 10 comprises two buffer portions 11. The two buffer portions 11 are two sides of the main body 10. Precisely, in this embodiment, the main body 10 is a solid shell and the thickness of the main body 10 is less than or equal to 3 mm, but it is not limited thereto. In another embodiment, the main body 10 may not be a solid shell, or the thickness of the main body 10 may be larger than 3 mm.

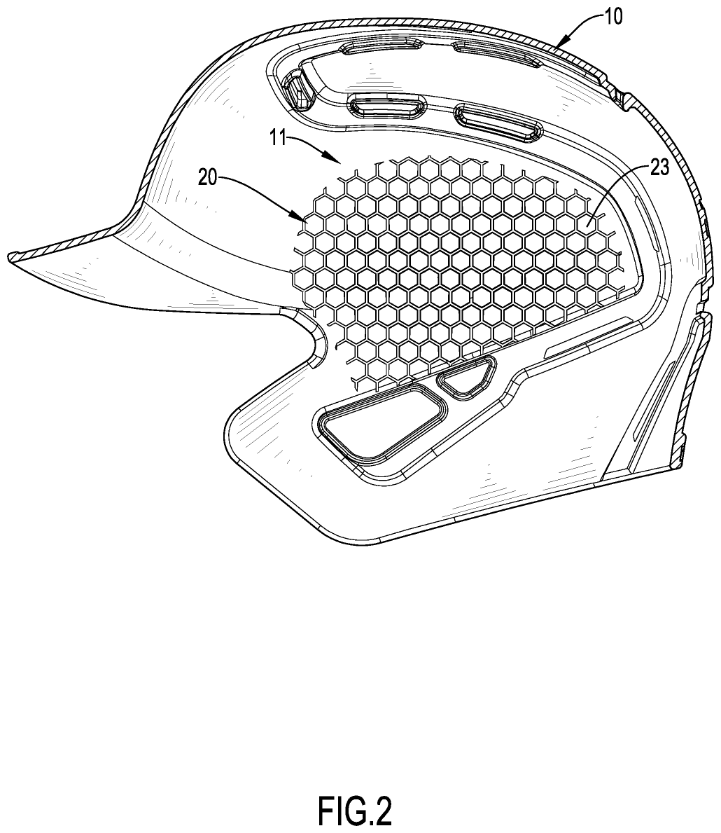

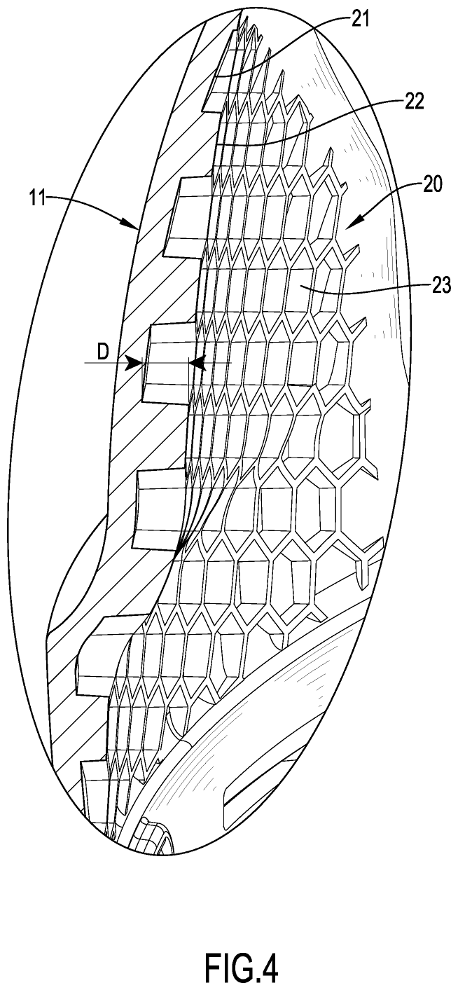

Then please refer to FIGS. 2 to 4. The two strengthening elements 20 are respectively mounted on inner walls of the buffer portions 11 of the main body 10. Each one of the strengthening elements 20 comprises a first surface 21, a second surface 22, and a plurality of through holes 23. The first surface 21 of each one of the strengthening element 20 is connected to and abuts the corresponding buffer portion 11. The second surfaces 22 of the strengthening elements 20 face to each other. Each one of the through holes 23 is formed through the corresponding strengthening element 20, through the first surface 21 and the second surface 22, and thereby the strengthening element 20 is latticed. In a preferred embodiment, a sectional area of each one of the through holes 23 is hexagonal. In other words, each one of strengthening elements 20 is arranged as a honeycomb grid, but it is not limited thereto. In another embodiment, the sectional areas of the through holes 23 may be rectangular, round, etc. Besides, in this embodiment, two curved surfaces of the first surface 21 and the second surface 22 are not parallel to each other. In other words, the curvatures of the first surface 21 and the second surface 22 are different from each other. A distance D between the first surface 21 and the second surface 22 is less than or equal to 6.5 mm. In other words, the thickness of the strengthening element 20 is not uniform. For example, an edge portion is thinner, a center portion is thicker, and the distance D at the thickest portion is 6.5 mm, but it is not limited thereto. In another embodiment, the thickness of the strengthening elements 20 may be uniform, or the thickness of the strengthening elements 20 may be larger than 6.5 mm.

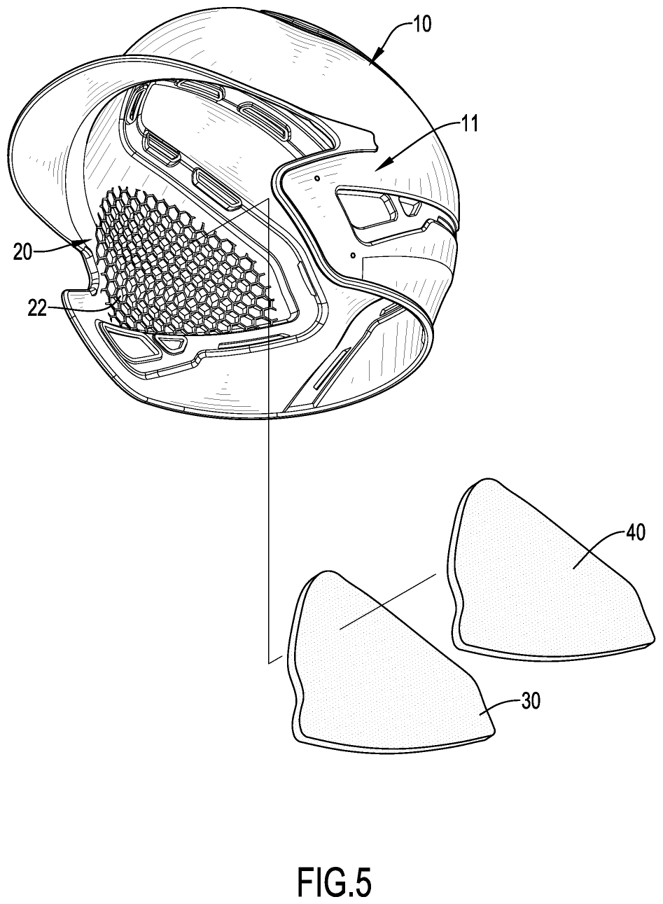

Then please refer to FIG. 5. The two first cushions 30 are respectively mounted on and cover the two second surfaces 22 of the strengthening elements 20. In this embodiment, the first cushions 30 are made of a polymer foam formed from ethene or ethenyl acetate, but it is not limited thereto. In another embodiment, the first cushions 30 may be made of other materials, or even may not comprise the first cushions 30.

The two second cushions 40 are respectively mounted on and cover the two first cushions 30. In this embodiment, the second cushions 40 are made of polyurethane foam, but it is not limited thereto. In another embodiment, the second cushions 40 may be made of other materials, or even may not comprise the second cushion 40.

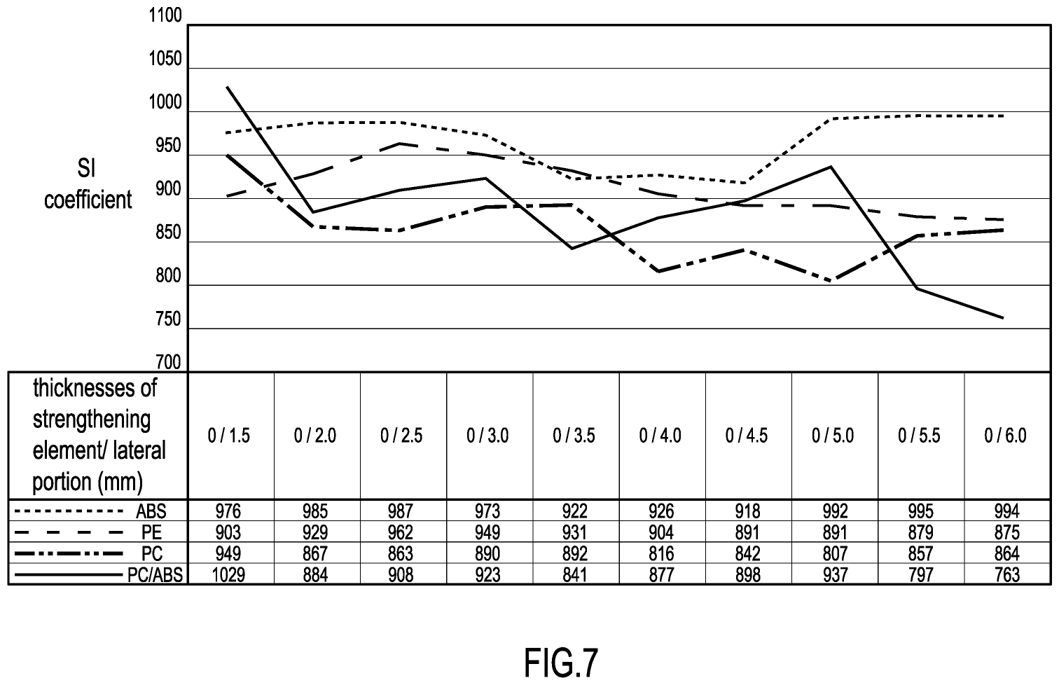

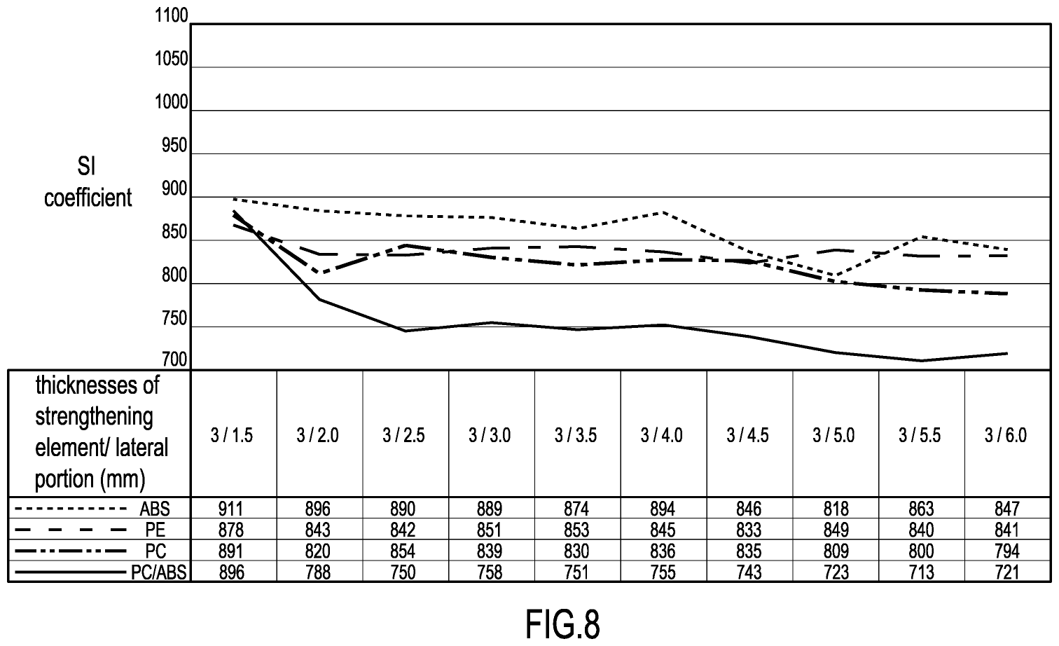

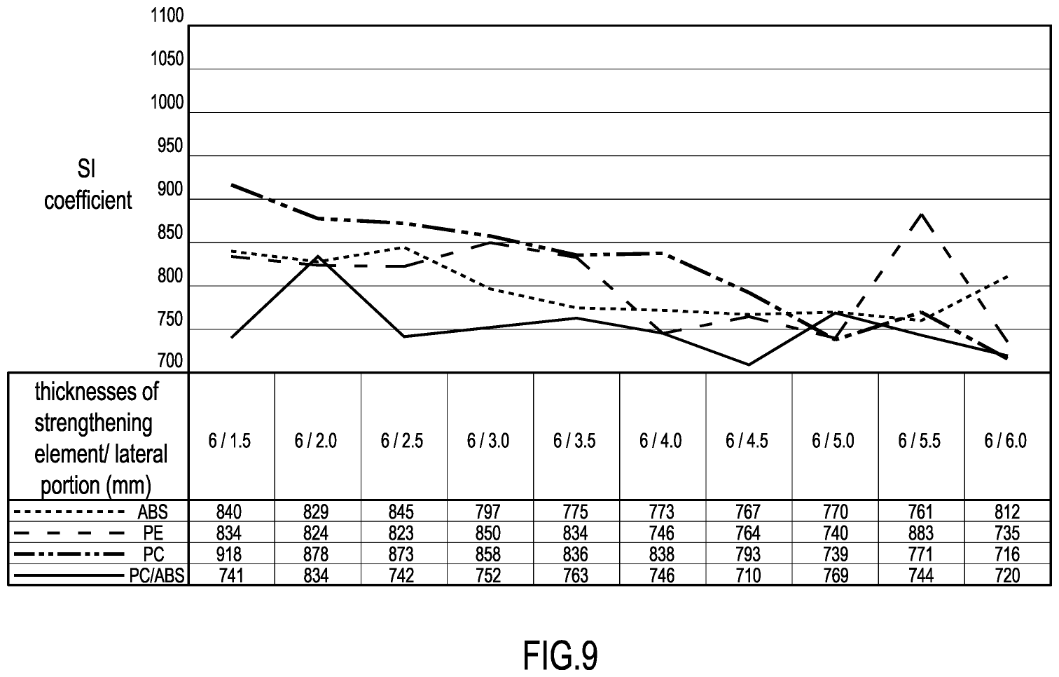

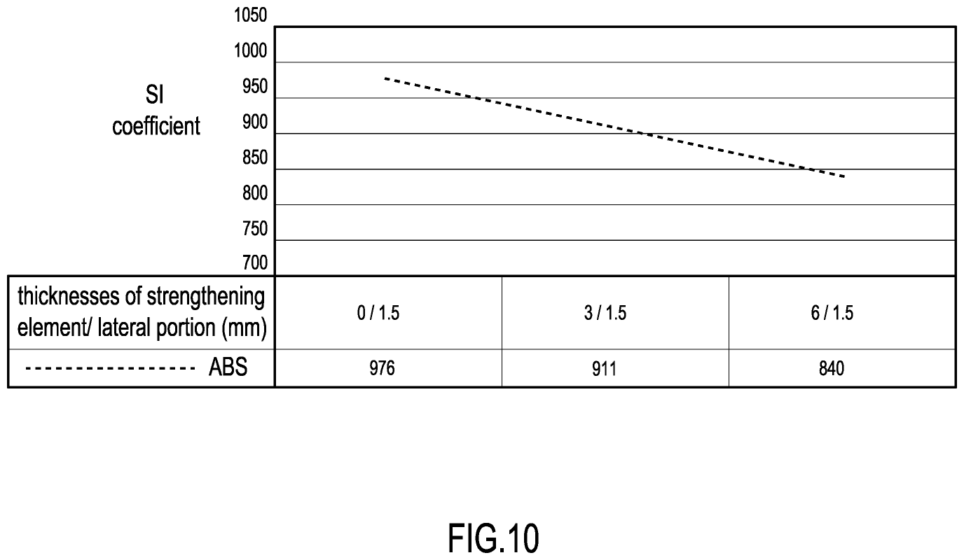

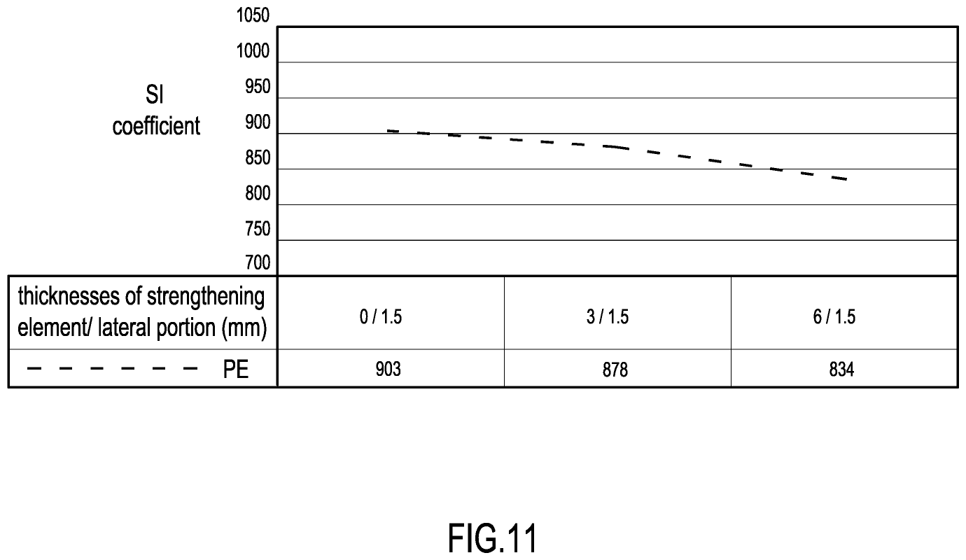

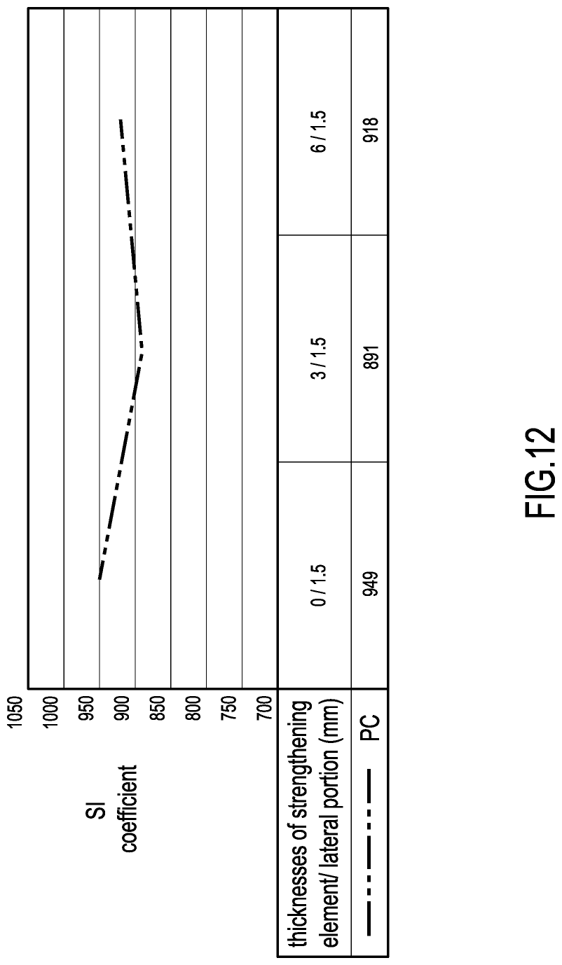

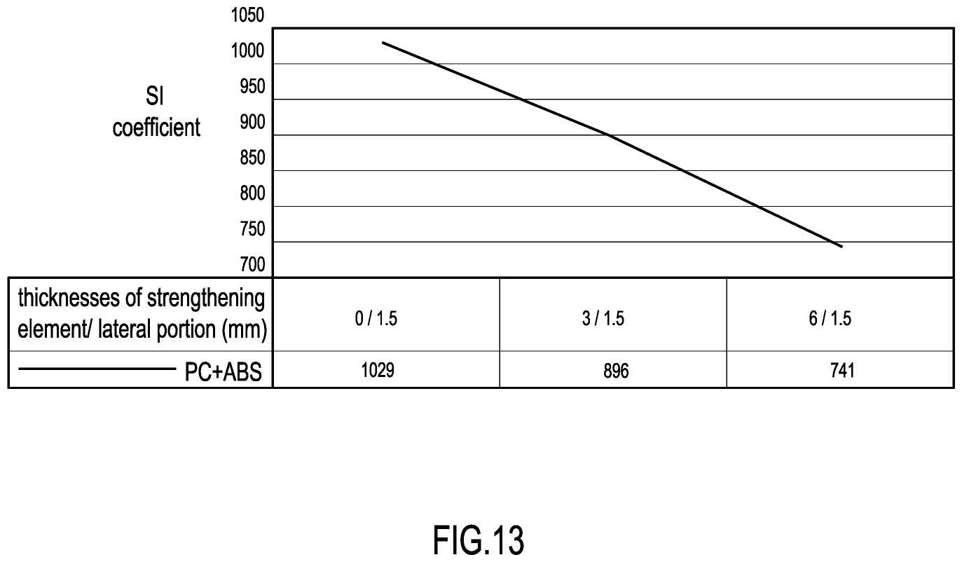

Then please refer to FIGS. 7 to 9. These three figures show experimental data of impacting experiments for the helmets made of four materials, i.e., ABS, PE, PC, and PC/ABS, in different structures. The vertical axes represent SI coefficient and the horizontal axes represent the thickness in millimeter. The SI coefficient is calculated through summing four areas that are between the horizontal axis and the curvatures of X, Y, and Z directional shocked amplitudes or the curvature of acceleration respectively (not shown in the drawings). The lower the SI coefficient is, the better the anti-impact capacity is. The two numbers on the horizontal axes represent the thicknesses of the strengthening elements 20 and the solid buffer portions 11. For example, in FIG. 7, the numbers 0/1.5 on the horizontal axis represent that the helmet does not comprise the strengthening element 20 and the thicknesses of the solid buffer portions are 1.5 mm; in FIG. 8, the numbers 3/4.5 represent the thicknesses of the strengthening elements are 3 mm and the thicknesses of the solid buffer portions are 4.5 mm. In view of FIGS. 7 to 9, the performances of the helmet without the strengthening element 20 are significantly affected by the various materials. However, with the thicker strengthening elements 20 mounted on the helmets, the performance differences between various materials are lower and less significant. Therefore, if the helmet is mounted with the strengthening elements 20 of an adequate thickness, the helmet can be made of lighter or cheaper material and thereby the cost of manufacturing or the weight of the helmet is minimized but the anti-impact capacity is not lost significantly. Then please refer to FIGS. 10 to 13. These four figures are experimental data of impacting experiments for the helmets made of the aforesaid four materials (i.e., ABS, PE, PC, and PC/ABS) with the thicknesses of the buffer portions 11 being 1.5 mm. In these four figures, the experiments compare the helmets without the strengthening element 20 and with the strengthening element 20 having the thickness ranging from 3 mm and 6 mm. According to FIGS. 9 to 13, except for the helmet made of PC, the anti-impact capacities of the helmets made of the remaining three materials are improved with the increasing thicknesses of the strengthening elements 20. Precisely, except for the helmet made of PC, the helmets made of the remaining three materials, having the buffer portions with the thicknesses of 1.5 mm, and mounted with the strengthening elements 20 with the thickness of 3 mm (i.e. the total thicknesses are limited under 4.5 mm), have slightly enhanced anti-impact capacities compared with the helmet in FIG. 7 that has buffer portions with the thicknesses of 4.5 mm. In other words, in the case of having the same total thickness, the anti-impact capacities of the solid-shell helmet and the helmet with the latticed strengthening elements 20 are almost the same. However, the weights of the latticed strengthening elements 20 and the amount of material for producing the latticed strengthening elements 20 are lower than those of the solid shell. Therefore, the latticed strengthening elements 20 may provide the same anti-impact capacity but lower the weight and the cost.

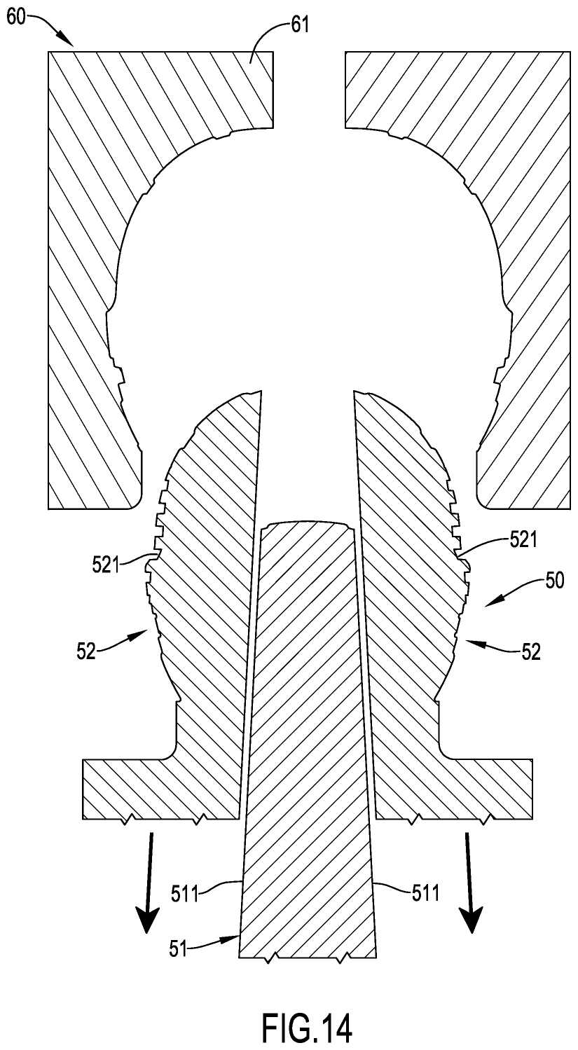

Please refer to FIGS. 14 to 19. The manufacturing method of producing a helmet with strengthening elements mounted on the buffer portions of the helmet includes the following processes.

First, as shown in FIG. 14, prepare a male die 50 and a female die 60. The male die 50 comprises a demolding member 51 and a plurality of lateral molding members 52. The demolding member 51 has a plurality of inclined surfaces each for driving a respective one of the lateral molding members 52. In this embodiment, the numbers of the lateral molding members 52 and the inclined surfaces of the demolding member 51 are, but not limited to, two. In this embodiment, two opposite lateral surfaces of the demolding member 51 are the inclined surfaces, which are defined as abutting surfaces 511 respectively. The two abutting surfaces 511 are inclined toward each other and a distance between the two abutting surfaces 511 gradually narrows upward. The two lateral molding members 52 clamp the demolding member 51 and abut the two abutting surfaces 511 respectively. Each one of the lateral molding members 52 has a latticed groove 521 formed concavely on a surface of the lateral molding member 52, said surface being the surface opposite the demolding member 51. The female die has a plurality of blocks 61, the blocks are separably abutted together and form a cavity between the blocks 61. In this embodiment, the number of the blocks 61 is two, but it is not limited thereto.

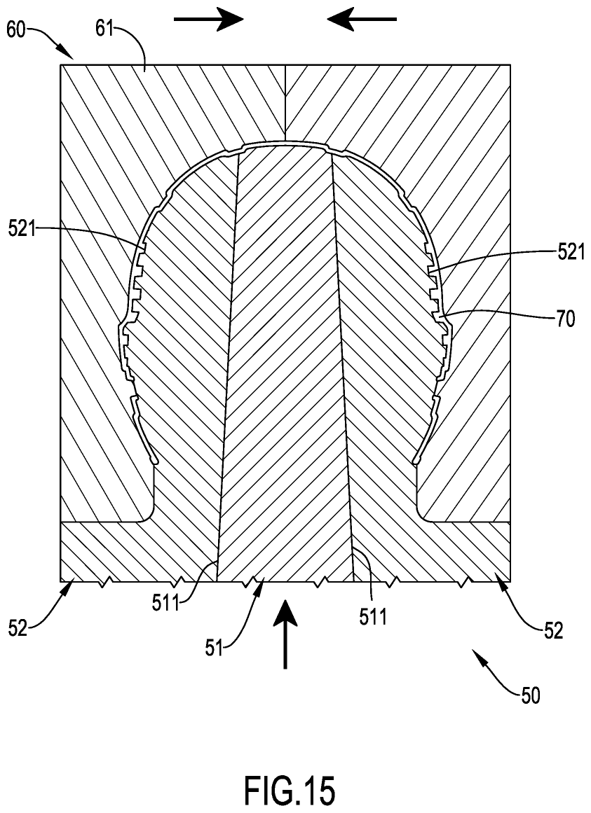

Second, as shown in FIGS. 14 and 15, insert the male die 50 into the female die 60. Precisely, the lateral molding members 52 are away from each other, and tip portions of the lateral molding members 52 and a tip portion of the demolding member 51 are aligned and thus the demolding member 51 and the lateral molding members 52 form a head shape. Then, the male die 50 is moved to a location between the blocks 61, and the blocks 61 are moved toward each other and thereby the blocks 61 are sleeved on the male die 50. Thus, the female die 60, the demolding member 51, and the pushed lateral molding members 52 form a mold cavity 70.

In this embodiment, as shown in FIG. 14, the lateral molding members 52 are moved outward and along the abutting surfaces 511 until the tip portions of the lateral molding members 52 are aligned to the tip portion of the demolding member 51. In another embodiment, the demolding member 51 is moved and drives the lateral molding members 52 to separate.

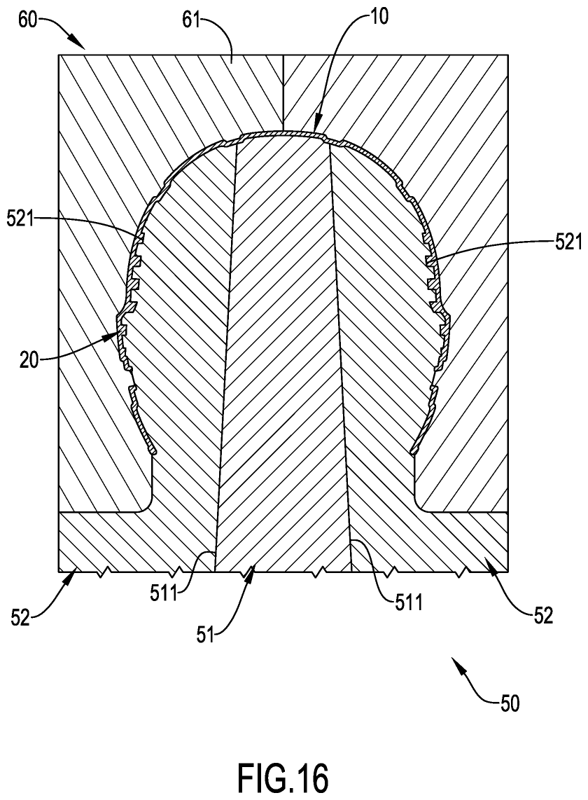

Third, as shown in FIG. 16, inject a liquid ingredient into the mold cavity 70 till the ingredient fills up the mold cavity 70 and every latticed groove 521 of the lateral molding members 52. After the ingredient is cured, the cured ingredient forms the aforesaid main body 10. Precisely, the latticed grooves 521 of the lateral molding members 52 shape the aforesaid strengthening elements 20 on the two inner walls that face to each other. Each strengthening element 20 comprises multiple through holes 23 so that the strengthening elements 20 are latticed.

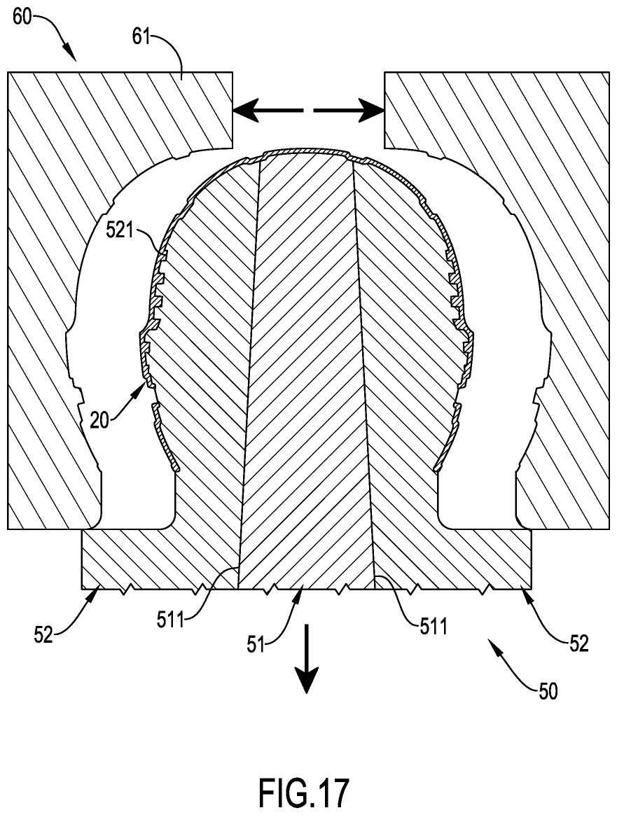

Fourth, as shown in FIG. 17, the blocks 61 separate from each other and thus the male die 50 and the helmet on the male die 50 are released. Then, the helmet on the male die 50 are moved away from the female die 60.

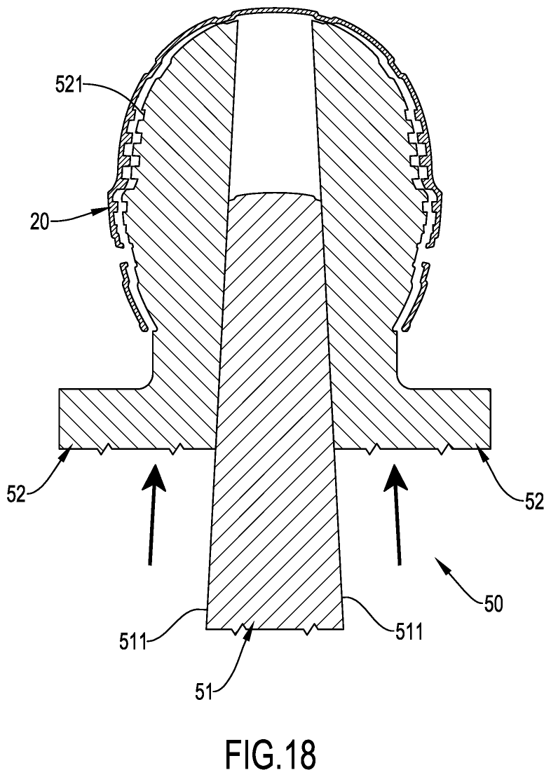

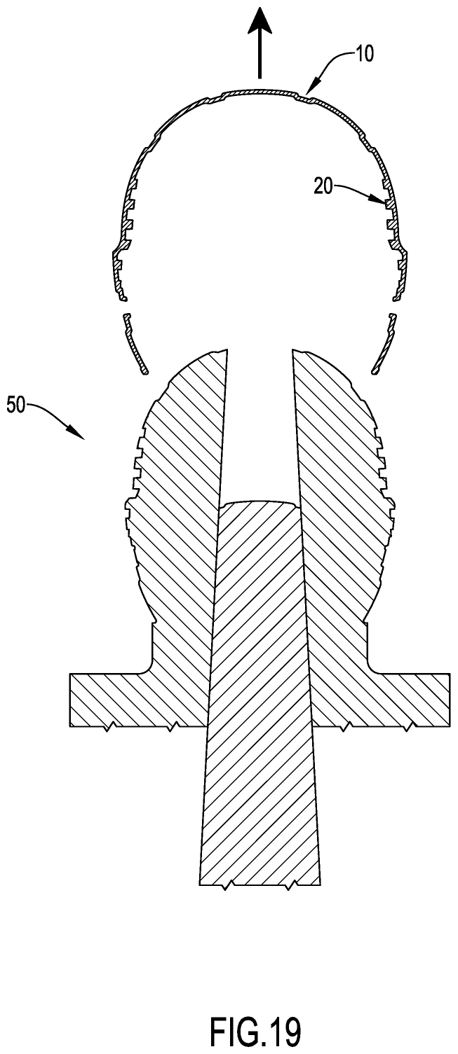

Fifth, as shown in FIGS. 18 and 19, the lateral molding members 52 are moved inward along the abutting surfaces 511 of the demolding member 51 and thereby the strengthening elements 20 respectively depart from the latticed grooves 521 of the lateral molding members 52 and thereby the helmet is released for the male die 50.

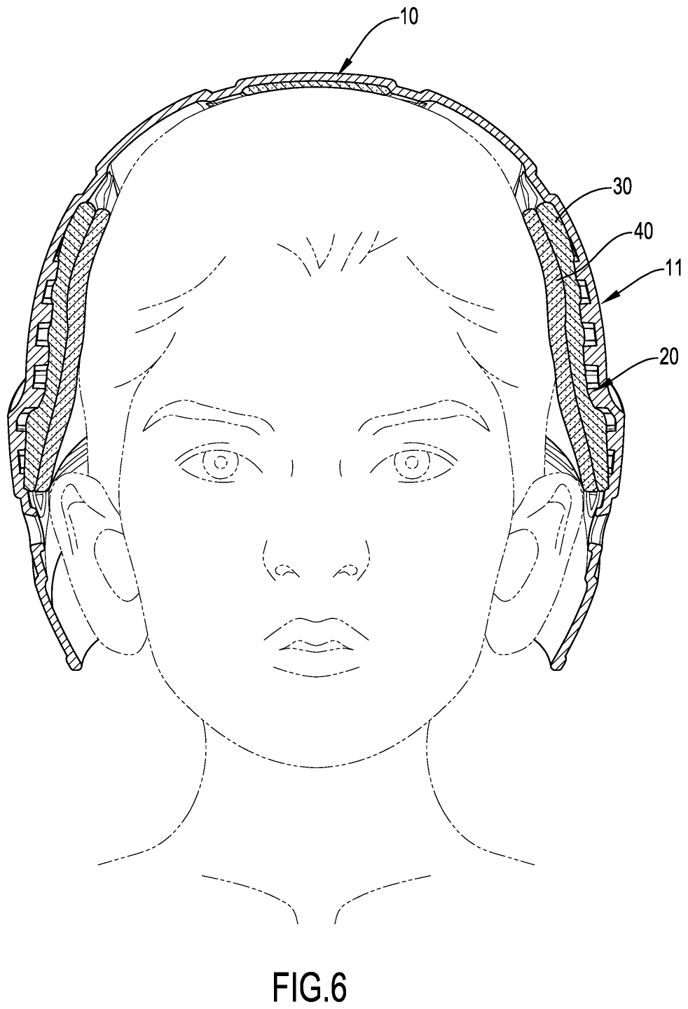

Then please refer to FIG. 6. When a user wears the helmet of the present invention, the two buffer portions 11 are faced to the lateral sides of the head of the user. With the thicknesses of the buffer portions 11 and the thicknesses of the strengthening elements 20 (i.e., the distance between the first surface 21 and the second surface 22) added together, the total thickness is increased and thus the anti-impact capacity of the buffer portions 11 is enhanced significantly. Besides, because the strengthening elements 20 are latticed, even though the thicknesses of the strengthening elements 20 are increased, the weights of the strengthening elements 20 may not be increased and may not cause a weighted burden to the neck of the user. Moreover, the first cushions 30 and the second cushions 40 in the present invention are made of two different materials, so that the user may feel more comfortable when wearing the helmet, and the force and the shock caused by the impact may be absorbed for protecting the head of the user.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A helmet comprising:
a main body comprising:
a plurality of buffer portions on an inner side of the main body; and
a plurality of strengthening elements respectively mounted on the buffer portions of the main body; each one of the strengthening elements including:
a first surface mounted on an inner wall of the corresponding buffer portion;
a second surface facing to the second surface of another strengthening element; and
a plurality of through holes formed through the first surface and the second surface, thereby the strengthening element being latticed.

2. The helmet as claimed in claim 1, wherein a sectional area of each one of the through holes of the strengthening elements is hexagonal in shape.

3. The helmet as claimed in claim 1, wherein the first surface and the second surface of each one of the strengthening elements are parallel to each other.

4. The helmet as claimed in claim 2, wherein the first surface and the second surface of each one of the strengthening elements are parallel to each other.

5. The helmet as claimed in claim 1, wherein a distance between the first surface and the second surface of each one of the strengthening elements is less than or equal to 10 mm.

6. The helmet as claimed in claim 4, wherein a distance between the first surface and the second surface of each one of the strengthening elements is less than or equal to 10 mm.

7. The helmet as claimed in claim 1, wherein the main body is a solid shell and a thickness of the main body is less than 3 mm.

8. The helmet as claimed in claim 6, wherein the main body is a solid shell and a thickness of the main body is less than 3 mm.

9. The helmet as claimed in claim 1, wherein the plurality of strengthening elements and the main body are formed integrally.

10. The helmet as claimed in claim 8, wherein the plurality of strengthening elements and the main body are formed integrally.

11. The helmet as claimed in claim 1 further comprising a plurality of first cushions respectively covering the second surfaces of the plurality of strengthening elements.

12. The helmet as claimed in claim 10 further comprising a plurality of first cushions respectively covering the second surfaces of the plurality of strengthening elements.

13. The helmet as claimed in claim 11 further comprising a plurality of second cushions covering the plurality of first cushions respectively.

14. The helmet as claimed in claim 12 further comprising a plurality of second cushions covering the plurality of first cushions respectively.

15. The helmet as claimed in claim 11, wherein the first cushions are made of a polymer foam formed from ethene or ethenyl acetate.

16. The helmet as claimed in claim 14, wherein the first cushions are made of a polymer foam formed from ethene or ethenyl acetate and the second cushions are made of a polyurethane foam.

17. The helmet as claimed in claim 1, wherein part of the buffer portions are formed on two lateral areas of the inner side of the main body.

18. The helmet as claimed in claim 1, wherein part of the buffer portions are formed on a top area, a rear area, or a front area of the inner side of the main body.

19. The helmet as claimed in claim 1, wherein the first surface and the second surface of each one of the strengthening elements are parallel to each other.

20. A manufacturing method of a helmet with strengthened buffer portions including processes in sequence as follows:
preparing a mode: the mode comprising:
a male die comprising:
a plurality of lateral molding members, each one of the lateral molding members having a polygonal latticed groove; and
a demolding member having a plurality of inclined surfaces each for driving a respective one of the lateral molding members;
a female die comprising a plurality of blocks; and
a mold cavity formed between the male die and the female die;
injecting a liquid plastic ingredient into the mold: the liquid ingredient injected into the mold cavity till the ingredient fills up the mold cavity and every latticed groove of the lateral molding members; after curing, the cured ingredient forming a helmet and strengthening elements; wherein the strengthening elements are formed in and shaped by the latticed grooves; and
releasing the helmet: the blocks of the female die separated from each other and thereby releasing the male die and the helmet on the male die; then, the lateral molding members moved inward along the inclined surfaces of the demolding member and thereby the strengthening elements respectively departing from the latticed grooves of the lateral molding members and thereby the helmet released.
